(19) United States
(12) Patent Application Publication
(10) Pub. No.: US 2010/0268723 A1
(43) Pub. Date: Oct. 21, 2010

(54) METHOD OF PARTITIONING A SEARCH QUERY TO GATHER RESULTS BEYOND A SEARCH LIMIT

(76) Inventor: Brian J. Buck, Lisle, IL (US)

Correspondence Address: SCHOX PLC, 500 3rd Street, Suite 515, San Francisco, CA, 94107, US

(21) Appl. No.: 12/425,702

(22) Filed: Apr. 17, 2009

(51) Int. Cl. G06F 17/30

(52) U.S. Cl. 707/759; 707/E17.014

(57) ABSTRACT

In one embodiment the invention includes a method to gather search results beyond a search result limit. In one embodiment, the method includes the steps of receiving a desired search term, creating a partitioning set that includes at least one partitioning term, forming a plurality of partitioned queries that include the desired search term and the partitioning set, submitting the plurality of partitioned queries to a query service, and collecting results from the submitted plurality of partitioned queries.

### TECHNICAL FIELD

This invention relates generally to the computer search field, and more specifically to a new and useful search result gathering method in the computer search field.

### BACKGROUND

Query services, such as a search engine, are capable of finding large volumes of data, documents, and files that meet a particular search query. A search query might have well over 1,000,000 results. Many of these query services are operated by an outside party and—for various reasons—the query services often place a result limit on the number of results returned by the query service. Many users do not need or desire all the results and only care about the most relevant results, but some applications call for all possible results to perform an analytical process. Thus, there is a need in the computer search field to create a new and useful method of gathering search results beyond the search limit. This invention provides such a new and useful method.

### BRIEF DESCRIPTION OF THE FIGURES

FIG. 1 is a flowchart of a preferred embodiment of the invention;

FIGS. 2A, 2B, 2C, and 2D are detailed views of variations of the step of creating a partitioning set of the preferred embodiment of the FIG. 1;

FIGS. 3A, 3B, and 3C are examples of the structure of partitioned queries;

FIG. 4 is a flowchart of an alternative embodiment of the invention using recursive partitioning;

FIG. 5 is a table of sample partitioned queries; and

FIG. 6 is a table of English words ranked by frequency.

### DESCRIPTION OF THE PREFERRED EMBODIMENTS

The following description of preferred embodiments of the invention is not intended to limit the invention to these preferred embodiments, but rather to enable any person skilled in the art to make and use this invention.

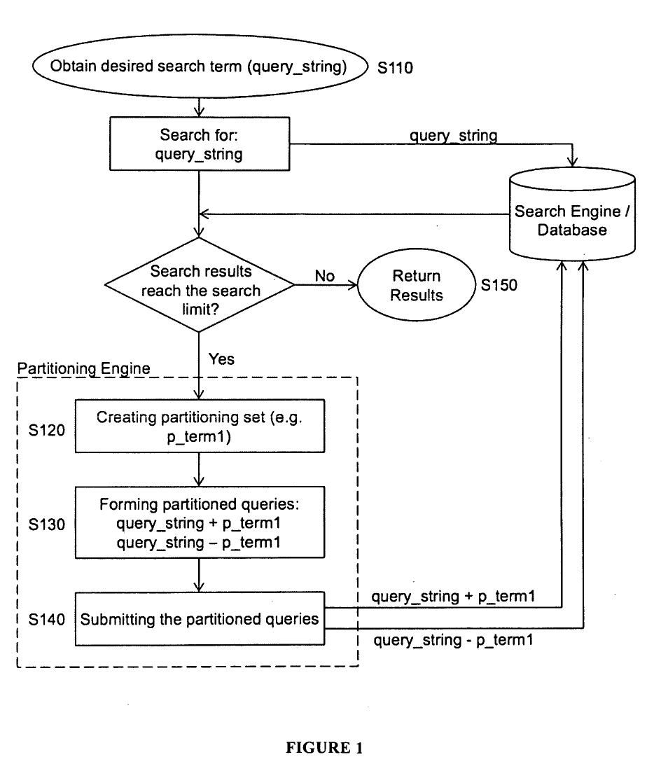

As shown in FIG. 1, the method of gathering search results beyond a search result limit of the preferred embodiment includes receiving a desired search term S110, creating a partitioning set S120, forming a plurality of partitioned queries S130, submitting the plurality of partitioned queries S140, and collecting results from the plurality of partitioned queries S150. The method functions to divide a search query into narrower search queries that preferably return fewer results than the search result limit. The more narrow searches preferably can be combined to reform all the results of the original search query. The method is preferably used on a third party query service. The query service is preferably a consumer based Internet search engine (e.g., Google, Yahoo, etc.), an organized database (e.g. library system, government records, inventory list, etc.), and/or any suitable searchable electronic collection. In the case of databases or any service which has “structured data” fields (as opposed to textual content), the “term” is preferably a “predicate” (e.g., FIELDA=“value1”). The method is preferably used to obtain all the results of a search query when a query service imposes a search result limit. The method may alternatively be used to divide a search into partitioned segments for process optimization, fetching results in smaller portions, automatically grouping search results, fetching results in an order such that more preferred results may be returned sooner, and/or any suitable application.

Step S110, which recites receiving a desired search term, functions to identify the main item of interest for the search query. The desired search term is preferably a textual term that a user and/or computer system desires to find within a set of documents or files. The desired search term may alternatively be a database field term, such as a search for a particular item or items within any given category of a database. The desired search term may additionally specify a range (e.g., a range of dates), include a combination of search elements, include Boolean operators, and/or include any suitable search query acceptable by a query service. Additionally, a preliminary search query preferably verifies if a desired search term has the results limited by the query service. A search result limit is preferably known a priori based on the query service being used. The total results may alternatively be compared to the number of accessible results. The search limit and/or total results may alternatively be determined by comparing various query services.

Step S120, which recites creating a partitioning set, functions to generate a term or terms that can be added to a search query to subdivide the results of a search query. The partitioning set preferably is composed of at least one partitioning term. The partitioning set may alternatively be composed of a plurality of partitioning terms. Additionally or alternatively, the partitioning set may be composed of groups of partitioning terms. The group of partitioning terms are preferably related terms and the terms are preferably grouped by a logical ‘OR’ statement or any suitable Boolean operator or other method of combining search elements. For example a group of partitioning terms may be organized as: “square OR block OR cube OR box”. Additionally multiple groups of terms may be used.

The selection of the partitioning terms of the partitioning set may be performed in several manners. The selection step preferably employs a priori statistics about the frequency of occurrence of the partitioning terms or predicates. The selection step may alternatively employ statistics gathered from all or part of an initial results set from an unpartitioned query. An entire set of partitioned queries (the partitioning set) is preferably constructed once frequencies are available, or accomplished incrementally and iteratively, recursively partitioning queries. Some query servers may only provide estimates of the number of total results, or may not provide estimates of the number of total results at all. In this scenario, the step preferably uses an incremental recursive approach as opposed to pre-computing a set of partitioning queries likely to all return fewer results than the search results limit. In one variation of predicates involving structured fields, statistics regarding the frequency of occurrence of discrete values or ranges for continuous-valued fields may be already available from the query service (as could be the case for relational database statistics which have been gathered for use by a Relational Database Management System's (RDBMS) query optimizer). The statistics regarding the frequency of occurrence of discrete values or ranges for continuous-valued fields may alternatively be pre-computed via a set of queries and/or calculations. A priori knowledge about the frequency of occurrence of values may additionally or alternatively be employed.

In the case of terms used for text query, a priori knowledge about term frequencies and average text field size may be used to estimate statistics regarding the effectiveness of a term for partitioning use. A simple model which assumes independence across term frequencies in a text field may be used to estimate from a frequency p for a term the probability q that the term will occur in a text field containing T terms: q=1−(1−p)^{T}. Other suitable models regarding the relation of term frequencies and text field frequencies may alternatively be employed.

A partitioning term or terms is preferably selected so as to partition the result set into two substantially equal-sized result sets. If a candidate term or predicate expression is available to do so, then the partitioned queries preferably consist of first the original query logically ANDed with the candidate term or predicate expression, and second the original query logically ANDed with the negation of the candidate term or predicate expression. In a variation, the candidate partitioning terms may not exist with term probabilities near one half; rather the candidate probabilities are much lower, e.g., 0.1. In this variation, partitioned queries are preformed preferably using in a first case the logical disjunction of N such lower probability candidate terms and in a second case the logical conjunction of the negation of those N terms. For example, if there were seven candidate terms T₁ through T₇, each with a term frequency probability of 0.1, the first partitioning query would append: (T₁ OR T₂ OR T₃ OR T₄ OR T₅ OR T₆ OR T₇). The second partitioning query would append: −T₁ −T₂ −T₃ −T₄ −T₅ −T₆ −T₇. With term frequency probabilities of 0.1, the partitioning effect of the first partitioning query would be (1−0.1)⁷=0.4782969, while the partitioning effect of the second partitioning query would be 0.5217031. For structured data fields, partitioning predicates may alternatively be constructed using values or ranges of values on fields already in the query, or can employ predicates referring to other data fields not already referenced in the query. The partitioning set may alternatively be created in any suitable manner

The partitioning set is preferably created using a partitioning engine. The partitioning engine is preferably a software program that preferably operates on a computer, a server, and/or any suitable computer system. The partitioning engine preferably accesses a database of partitioning terms. In one preferred embodiment, the database stores a list of partitioning terms that are statistically optimal partitioning terms. An optimal partitioning term in this document is preferably understood to mean a term that will appear in approximately half of a sample of documents. An optimal partitioning term may alternatively be understood to be a term found in any suitable percentage number of documents such as a term found in 30% to 70% of scanned documents. A statistically optimal partitioning term is a term that based on prior knowledge is expected to be an optimal partitioning term in another set of documents.

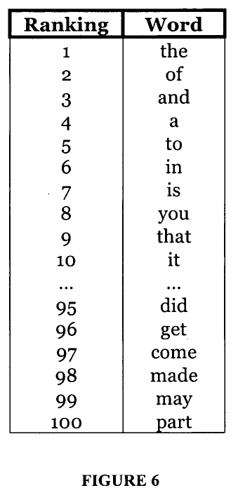

In an example of partitioning terms selection/construction, a text field size of 1000 terms would preferably select terms from a term frequency list having rank order near 100. By Zipf's Law, the probability of occurrence of a word in a natural language text is proportional to the inverse of the rank order. The term frequency list is preferably found in a reference with a list of the most frequently occurring English words (such as ref. The Reading Teachers Book of Lists, Third Edition; by Edward Bernard Fry, Ph. D, Jacqueline E. Kress, Ed. D & Dona Lee Fountoukidis, Ed. D.). As shown in FIG. 6, the most frequently occurring word “the” has a frequency of about 0.07. The 100^{th} ranked word is “part,” with a frequency of about 0.0007. The preferred model for computing text-field probability computes 1−(1−0.0007)¹⁰⁰⁰=0.503536401. Choosing the term “part” for partitioning would be a preferred choice. The simple model computes a text-field probability for “the” that is extremely close to one, and thus unsuitable for use as a partitioning term: 1−(1−0.07)¹⁰⁰⁰=1−3.0405×10⁻³².

The partitioning terms of the database are preferably ordered and selected for use in the partitioning set based on the probability of the term evenly partitioning a search query. In one embodiment, the database is a collection of terms that are statistically optimal partitioning terms for documents from a known language. The database is preferably created by analyzing a substantially large sample of documents. In an alternative embodiment, a specialized database of terms is kept for various domains of information. For example, a particular technology, industry, company, and/or other entity may have an associated database. The specialized database is preferably in the same domain as the desired search query. As another alternative embodiment, the database may be a collection of terms that optimally partition results from a previous search. The previous search (a preceding search) may be from a limited search result performed with the desired search query, or the previous search may alternatively be from a submitted partitioned query (preferably performed when using the method in a recursive embodiment). A preceding partitioning set is preferably associated with a preceding search that is partitioned query. The partitioning set may alternatively be created using any number of databases, combination of the described methods, and/or suitable alternatives.

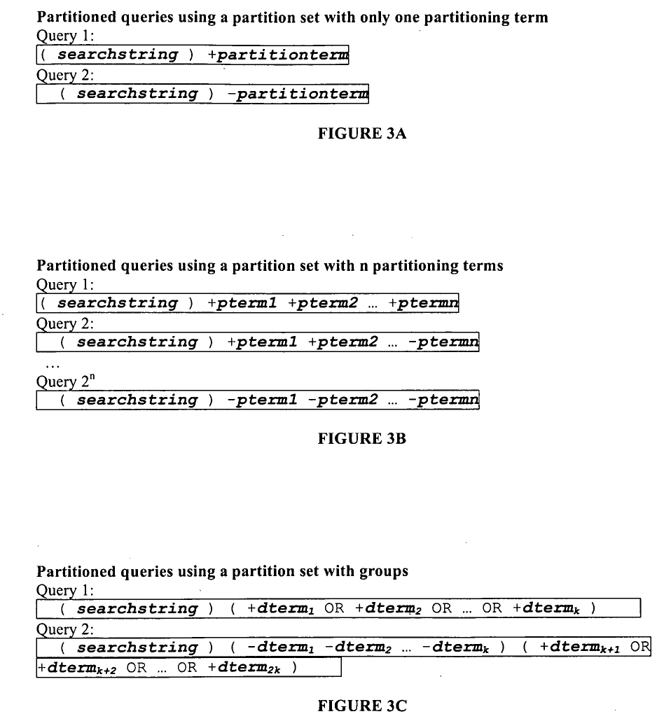

Step S130, which recites forming a plurality of partitioned queries, functions to form multiple queries from the desired search term and the partitioning set. The forming of a plurality of partitioned queries is preferably performed by the partitioning engine, a computer program, and/or by any suitable means. The partitioned queries are preferably unique and complimentary in that each partitioned query does not intersect with a second partitioned query. The partitioned queries preferably capture or describe the whole collection of results from the desired query (i.e. the query using the desired search term). A partitioned query may alternatively intersect with a second partitioned query, and the plurality of partitioned queries may alternatively capture or describe a portion of the results from the desired query. The partitioned queries preferably include the desired search term and the partitioning set. The partitioned queries preferably utilize the inclusion and/or exclusion features of a query service when combining the desired search term with the partitioning set. The inclusion feature is preferably represented by a logical AND, a ‘+’, and/or any suitable symbol or means of including a search term(s). The exclusion feature is preferably represented by a logical ANDNOT, a ‘−’, and/or any suitable symbol or means of excluding a search term(s). As shown in FIGS. 3A, 3B, and 3C, every permutation of inclusion and exclusion of a partition term or terms is preferably used. A partitioned query preferably has a complimentary partitioned query included in the plurality of partitioned queries. In an example of a partitioning set with one partition term, a first partitioned query includes the desired search term and the inclusion of the partitioning term; and a second partitioned query includes the desired search term and the exclusion of the partitioning term. In another example, when there are ‘n’ number of partitioning terms then there will be 2ⁿ unique partitioned queries. The plurality of partitioning terms may alternatively be formed in any suitable manner.

Step S140, which recites submitting the plurality of partitioned queries, functions to find results from a query service based on the partitioned queries. The partitioned queries are preferably submitted over a network or Internet. The partitioning engine preferably handles the submission of the partitioned queries, but any suitable method of submission may alternatively be used. The plurality of partitioned queries is preferably submitted in parallel by accessing the query service through multiple connections and/or sessions. The plurality of partitioned queries may alternatively be submitted in series where each partitioned query is submitted individually, one after the other. The partitioned queries may additionally be separated in time to prevent bandwidth restrictions, reduce network connections, reduce resource usage, and/or avoid time based restrictions. The returned results of a first partitioned query may be received before other partitioned queries have been submitted. The returned results of a first partitioned query may affect a following partitioned query. In one example, if a partitioning term does not adequately partition a search (does not divide the desired query evenly or at all), that partitioned term may not be included in the partitioning set for later partitioned queries. A new partitioning term may alternatively be used in the place of the first partitioning term.

Step S150, which recites collecting results from the plurality of partitioned queries S150, functions to organize all the partitioned query results returned by the query service. The results are preferably combined into a single collection, but alternatively the results may be organized based on the partitioned queries. The results of a partitioned query may additionally require crawling of a website or database to access all the results. The results may be returned as HTML with the total results distributed over multiple pages. The results of each HTML page are preferably collected and organized in any suitable format. As an additional step, the results may be provided to a secondary system or program. The secondary system or program preferably post-processes all the results, and more preferably refines the results (such as removing redundancy or undesired results).

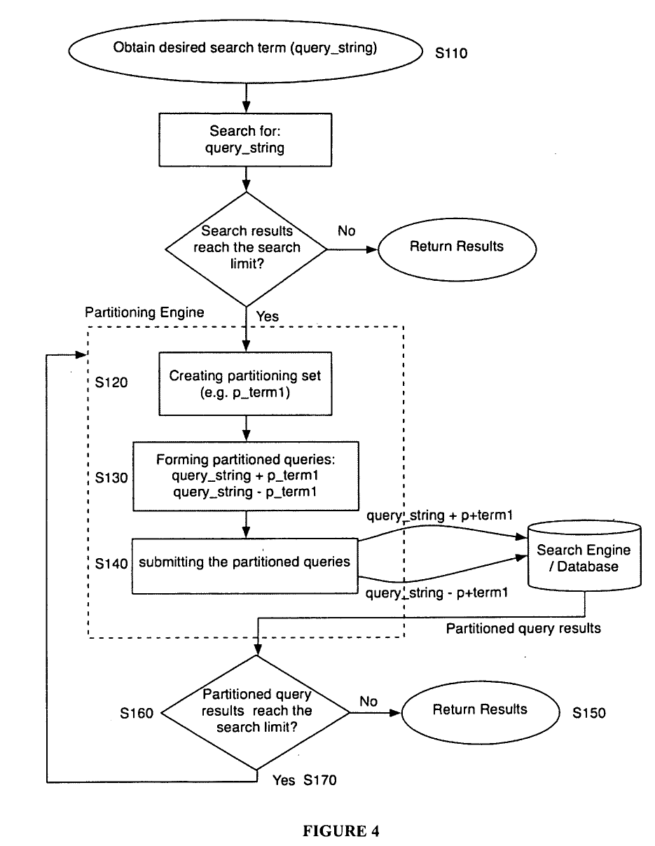

As shown in FIG. 4, the method of the preferred embodiment may additionally be implemented as a recursive algorithm that includes the steps comparing the number of results form a partitioned query to the search result limit S160, and repeating partitioning steps for a partitioned query that has more results than the search result limit S170. The recursive version functions to repeatedly partition the desired query until all results are obtained.

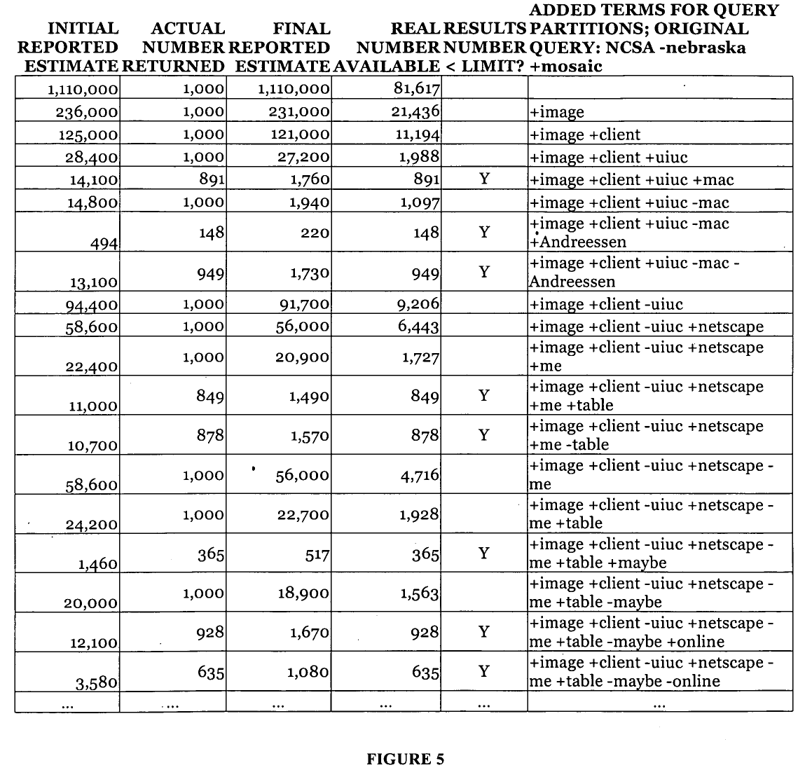

Step S160, which recites comparing the number of results from a partitioned query to the search query limit, functions to identify partition queries that have results limited by a search result limit and require further partitioning. As shown in FIG. 5, a partitioned query is preferably recursively repartitioned until the partitioned query results are not limited by a search result limit. A partition query may alternatively be recursively repartitioned up to a maximum number of times or any suitable number of times. A search result limit is preferably known a priori based on the query service being used. The total results may alternatively be compared to the number of accessible results. The search limit and/or total results may alternatively be determined by comparing the number of results from various services. In one version, where the search limit and/or total results are unknown, the method may include recursively repartitioning until the number of results reaches a steady state value.

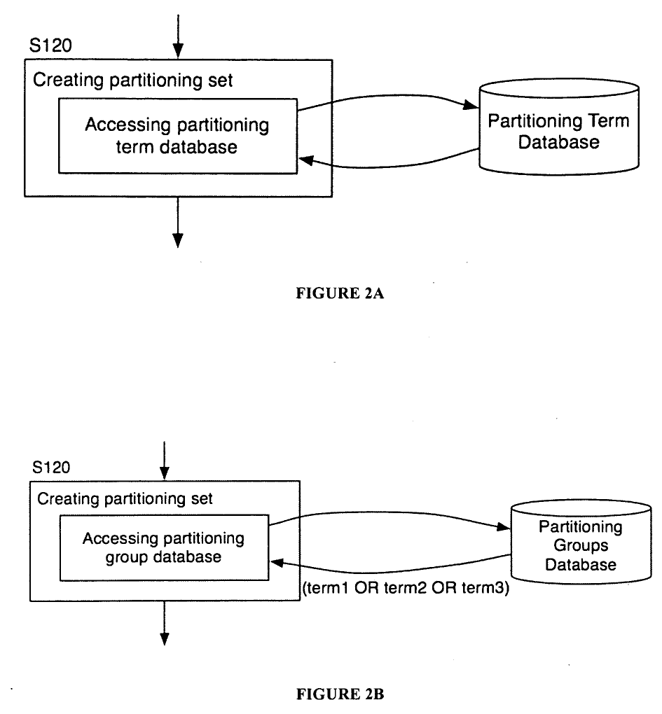

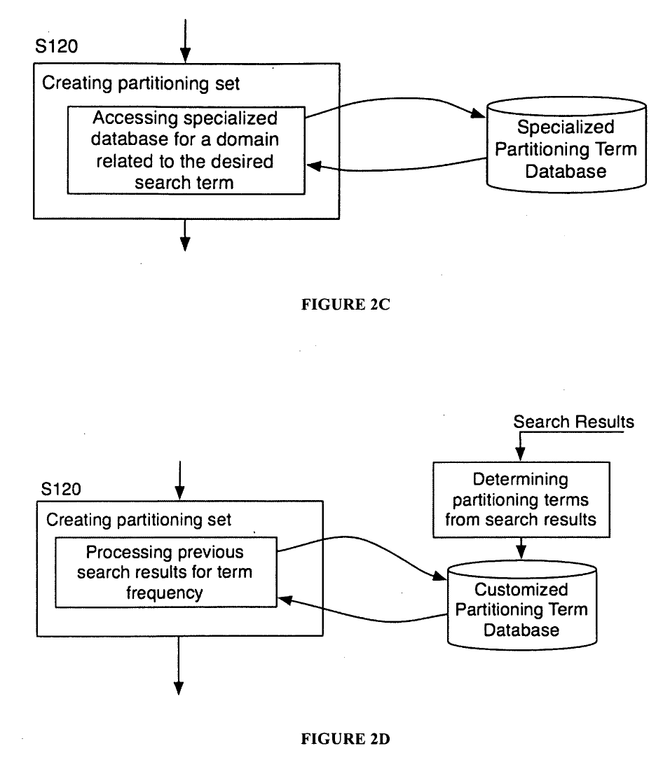

Step S170, which recites repeating partitioning steps for a partitioned query that has more results than the search result limit, functions to divide a partitioned query into additional plurality of partitioned queries. The partitioning engine preferably repeats the process of partitioning Steps S120, S130, S140, and S150. The repeating of the partitioning steps preferably uses the partitioned query (the desired search term combined with the previous partitioning set) as a desired search term and adds an additional partition set. The partition set may alternatively be altered during the repartitioning. For example, a partitioned query that has been through the recursive step might be organized as: ((desired_query−partition_set_{—}1)+partition_set_{—}2). The previous partition set may alternatively not be used in a repeated partitioning step. The results of a partitioned query may additionally be analyzed to create an updated database of partitioning terms, as shown in FIG. 2D. A subset of results is preferably analyzed but all of the returned results may alternatively be analyzed. The analysis preferably identifies statistically optimal partitioning terms for the repeated partitioning step.

As a person skilled in the art will recognize from the previous detailed description and from the figures and claims, modifications and changes can be made to the preferred embodiments of the invention without departing from the scope of this invention defined in the following claims.

I claim:

1. A method to gather search results beyond a search result limit comprising the steps of:
receiving a desired search term;
creating a partitioning set that includes at least one partitioning term;
forming a plurality of partitioned queries that include the desired search term and the partitioning set;
submitting the plurality of partitioned queries to a query service; and
collecting results from the submitted plurality of partitioned queries.

2. The method of claim 1, wherein the step of creating a partitioning set is performed by a partitioning engine.

3. The method of claim 2, wherein the step of creating a partitioning set is performed by a partitioning engine on a server.

4. The method of claim 2, wherein the partitioning term is selected from the group consisting of a textual term, a database field term, and a database field range.

5. The method of claim 4, wherein the desired search term is selected from the group consisting of a textual term, a database field term, and a database field range.

6. The method of claim 5, wherein the query service is a third party search engine.

7. The method of claim 6, wherein the third party search engine may be accessed by the public to submit a query to a structured database.

8. The method of claim 6, wherein the plurality of partitioned queries are submitted in parallel to the query service.

9. The method of claim 6, wherein the plurality of partitioned queries are submitted in series to the query service.

10. The method of claim 9, further including: submitting a preceding query to a query service, and collecting results from the preceding query; wherein the steps of submitting a preceding query and collecting results from the preceding query are performed before the step of creating a partitioning set, and the step of creating a partitioning set further includes the step: processing results from the preceding query to create a partitioning set.

11. The method of claim 10, wherein the preceding query is a partitioned query formed from a preceding partitioning set that includes at least one preceding partitioning term.

12. The method of claim 11, further including reusing a part of the preceding partitioning set for the partitioning set.

13. The method of claim 12, further including adding a new partitioning term to the preceding partitioning set to form the partitioning set.

14. The method of claim 12, further including using a new partitioning term in place of a preceding partitioning term to form the partitioning set.

15. The method of claim 5, wherein the step of creating a partitioning set further includes accessing a database of partitioning terms.

16. The method of claim 15, wherein the database is a collection of terms that statistically partition a sample of documents into suitably distinct divisions.

17. The method of claim 16, wherein the sample of documents is from a set language.

18. The method of claim 16, wherein the database is a collection of terms that are relevant to a domain of the desired search query and that partition a sample of documents into suitably distinct divisions.

19. The method of claim 15, wherein the database is formed by identifying terms that statistically partition a collection of previous search results into suitably distinct divisions.

20. The method of claim 15, wherein the partitioning set divides the whole search results into complimentary sets that combine to form the whole search result.

21. The method of claim 15 further including submitting a first partitioned query that combines a desired search term and the inclusion of a first partitioning term; and submitting a second partitioned query that combines a desired search term and the exclusion of the first partitioning term.

22. The method of claim 15 wherein the partitioning set includes a plurality of partitioning terms.

23. The method of claim 22 wherein the partitioning set includes a second partitioning term, and the method further including the steps:
submitting a first query that combines the desired search term with the inclusion of the first partitioning term and the second partitioning term;
submitting a second query that combines the desired search term with the inclusion of the first partitioning term and the exclusion of the second partitioning term;
submitting a third query that combines the desired search term with the exclusion of the first partitioning term and the inclusion of the second partitioning term; and
submitting a fourth query that combines the desired search term with the exclusion of the first partitioning term and the second partitioning term.

24. The method of claim 22 wherein the partitioned queries are unique and the possible combinations of inclusion and exclusion of the partitioning terms amount to two raised to the number of partitioning terms.

25. The method of claim 15 wherein the partitioning set includes a partitioning term that is a group of terms.

26. The method of claim 25, wherein the group of terms are combined using a logical OR statement.

27. The method of claim 15, wherein the further processing includes refining the relevant items.

28. The method of claim 15, further including the steps:
comparing the number of results from a partitioned query to the search result limit; and
repeating the partitioning steps for a partitioned query.

29. The method of claim 28, wherein a partitioned query repeats the partitioning steps when the partitioned query has more results than the search result limit.

30. The method of claim 29, wherein the database is formed by identifying terms that statistically partition a collection of previous search results into suitably distinct divisions.
